(19) United States
(12) Patent Application Publication
(10) Pub. No.: US 2015/0211362 A1
(43) Pub. Date: Jul. 30, 2015

(54) SYSTEMS AND METHODS FOR MONITORING DRILLING FLUID CONDITIONS

(71) Applicant: James Bryon Rogers, Katy, TX (US)

(72) Inventor: James Bryon Rogers, Katy, TX (US)

(73) Assignee: CHEVRON U.S.A. INC., San Ramon, CA (US)

(21) Appl. No.: 14/567,671

(22) Filed: Dec. 11, 2014

Related U.S. Application Data
(60) Provisional application No. 61/933,753, filed on Jan. 30, 2014.

(51) Int. Cl. E21B 49/08; G01L 7/00; G01K 17/00

(52) U.S. Cl. CPC E21B 49/08; G01K 17/00; G01L 7/00

(57) ABSTRACT

Systems and methods are provided for monitoring a well for unwanted formation fluid influx and unwanted drilling fluid losses during a period in which drilling operations are performed for the well. Systems include at least two transducers spaced apart along a bell nipple or riser of a well system at a position below a flow line. The transducers obtain pressure and temperature differentials and are electronically coupled to a transmitter that transmits the measurements to a computer. Methods include utilizing this data to determine properties of the fluid in the well and can be utilized for kick detection. The measurements can be taken in a continuous and real-time fashion.

### CROSS-REFERENCE TO RELATED APPLICATIONS

The present application claims priority to U.S. Provisional Patent Application No. 61/933,753 titled “SYSTEMS AND METHODS FOR MONITORING DRILLING FLUID CONDITIONS” and filed Jan. 30, 2014, the entire contents of which are incorporated herein by reference.

### TECHNICAL FIELD

The present invention relates generally to drilling of wells in subsurface formations. More particularly, the invention relates to monitoring and detecting kicks in a well.

### BACKGROUND

The drilling of many oil and gas wells with a rotary drilling rig requires the use of weighted drilling fluid, called drilling mud, in the wellbore. The mud is used for multiple purposes, including cooling of the drill bit, removal of drilled cuttings from the drill bit, transport of the cuttings from the bottom of the wellbore to the surface, stabilizing the walls of the borehole, and providing a barrier to prevent formation fluids from entering the wellbore.

It is generally desirable to maintain the mud weight at an appropriate density in order to prevent fluid losses due to formation fracturing from excessive mud weight pressure and to prevent formation fluid influxes, known as “kicks”, from mud weight that is insufficient to hold the formation fluids in place. The difference between the minimum and maximum allowable mud densities, usually expressed as mud weights, necessary to maintain control of the well is known as the “drilling window”.

If the mud weight is insufficient and the lighter formation fluids enter the wellbore, the drilling mud will effectively be diluted, which will further reduce the mud density. The condition may continue to worsen over time because as the density of the drilling mud decreases, a lower pressure is exerted on the formation, and more of the formation fluids will flow into the wellbore. When the flow of formation fluids into the wellbore becomes so great that it cannot be controlled, the condition known as a “blowout” occurs. It is therefore desirable and advantageous to know as soon as possible if the density of the drilling mud returning from the bottom of the wellbore is changing.

It is common practice in the drilling industry to hire a mud service company to provide mud engineers at the rig site. One of the tasks of the mud engineer is to periodically perform a “mud check” in which he uses portable instruments and methods well known in the industry to determine the properties of the mud, such as mud density or weight. This check of the mud properties may occur relatively infrequently however, such as only several times per day, resulting in latent information about the condition of the mud properties. It is therefore desirable to have a system which monitors the density of the mud in a more timely manner so that the control of the well can be managed in a more proactive fashion.

In U.S. Pat. No. 3,827,295, a system is disclosed that monitors for changes of height of a fluid in a Bell Nipple using an air supplied bubble tube as an indication of a gas kick in the wellbore. The method and system is inadequate because it relies on a regulated supply of air bubbles to the pressure tube which is prone to inaccuracies, freezing of the air, fluctuations in temperature, and frequent maintenance and calibration issues. Also, the system is designed to monitor only for gas kicks, and not fluid kicks.

In U.S. Pat. No. 4,408,486, a system is disclosed that monitors the density of a fluid in a Bell Nipple using two supplied air bubble tubes as a means to determine the amount of entrained gas bubbles in the mud. The system suffers the same disadvantages as the previously mentioned system.

In U.S. Publication No. 2013/0298696, a system is disclosed which calculates the volume of mud flow out of a wellbore using a series of pressure transducers in a Bell Nipple and a trained neural network. The flow out of the wellbore is compared to the flow into the wellbore which is determined by a separate flow meter. A discrepancy between the flow in and flow out is used to indicate a kick or fluid loss. The system is inadequate in that it must be thoroughly calibrated using a series of tests with known quantities and densities of fluids prior to deployment on the well. This system is also very equipment intensive which leads to maintenance and support issues.

Therefore a need exists for a simpler, more robust and timely system and method to determine the properties of fluid returning from the wellbore primarily as an early indicator of possible kicks.

### SUMMARY

According to one aspect of the present disclosure, a system for monitoring and detecting formation fluid influxes and drilling fluid losses in a well includes a blowout preventer stack, a bell nipple or riser coupled to the blowout preventer stack, and a flow line coupled to a side of the bell nipple. A drill pipe extends through the bell nipple, the blowout preventer stack, and into the well. Fluid flows through the drill pipe into the well and returns through an annulus between the drill pipe and the bell nipple. The system also includes a monitoring system. The monitoring system is coupled to the bell nipple. The monitoring system includes at least two transducers disposed on the bell nipple and in contact with fluid flowing through the bell nipple. The at least two transducers are spaced a distance apart. The monitoring system also includes a transmitter electronically coupled to the at least two transducers configured to receive outputs from the at least two transducers. The monitoring system further includes a data receiving station in communication with the transmitter configured to receive a data signal from the transmitter.

According to another aspect of the present disclosure, a drilling fluid monitoring system includes a bell nipple, a flow line, and a monitoring system. The bell nipple is configured to receive a drilling fluid flowing therethrough. The flow line is coupled to and in fluid communication with the bell nipple, wherein the drilling fluid flows into the flow line from the bell nipple. The monitoring system is coupled to the bell nipple. The monitoring system includes at least two transducers disposed on the bell nipple and in contact with the drilling fluid flowing through the bell nipple. The at least two transducers are spaced a distance apart. The monitoring system further includes a transmitter. The transmitter is electronically coupled to the at least two transducers and configured to receive outputs from the at least two transducers. The monitoring system also includes a data receiving station in communication with the transmitter and configured to receive a data signal from the transmitter.

According to another aspect of the present disclosure, a method of monitoring and detecting formation fluid influxes and drilling fluid losses in a well includes acquiring well fluid outflow measurements using pressure and temperature transducers spaced apart a length along a bell nipple during a period in which drilling operations are performed for the well. The method also includes determining a pressure differential of a static head of a return fluid in an annular space of the bell nipple across the length along the bell nipple during the period. The method further includes determining a density of the return fluid in the bell nipple annular space from the differential pressure and temperatures. The method also includes determining a level and changes to the level of the return fluid in the bell nipple annular space from the determined density and the static head pressures and temperatures.

### BRIEF DESCRIPTION OF THE DRAWINGS

The drawings illustrate only example embodiments of the present disclosure, and are therefore not to be considered limiting of its scope, as the disclosures herein may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements. In one or more embodiments, one or more of the features shown in each of the figures may be omitted, added, repeated, and/or substituted. Accordingly, embodiments of the present disclosure should not be limited to the specific arrangements of components shown in these figures.

FIG. 1 illustrates a system for monitoring fluids returning from a well, according to an example embodiment.

FIG. 2 illustrates a method of monitoring and detecting formation fluid influxes and drilling fluid losses, according to an example embodiment.

### DESCRIPTION OF THE INVENTION

The present invention relates to the drilling of oil and gas wells with a rotary drilling rig. The density of the drilling fluid returning from the wellbore is derived from the differential pressure calculated from the measurement of the hydrostatic head at two vertically spaced points in the rig bell nipple. Significant changes to the derived density and level of the return fluid are used as an indicator that conditions have changed in the wellbore.

Illustrative embodiments of the invention are described below. In the interest of clarity, not all features of an actual implementation are described in this specification. One of ordinary skill in the art will appreciate that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention may be better understood by reading the following description of non-limitative embodiments with reference to the attached drawing wherein like parts of each of the figures are identified by the same reference characters. The words and phrases used herein should be understood and interpreted to have a meaning consistent with the understanding of those words and phrases by those skilled in the relevant art. No special definition of a term or phrase, for example, a definition that is different from the ordinary and customary meaning as understood by those skilled in the art, is intended to be implied by consistent usage of the term or phrase herein. To the extent that a term or phrase is intended to have a special meaning, for instance, a meaning other than that understood by skilled artisans, such a special definition will be expressly set forth in the specification in a definitional manner that directly and unequivocally provides the special definition for the term or phrase.

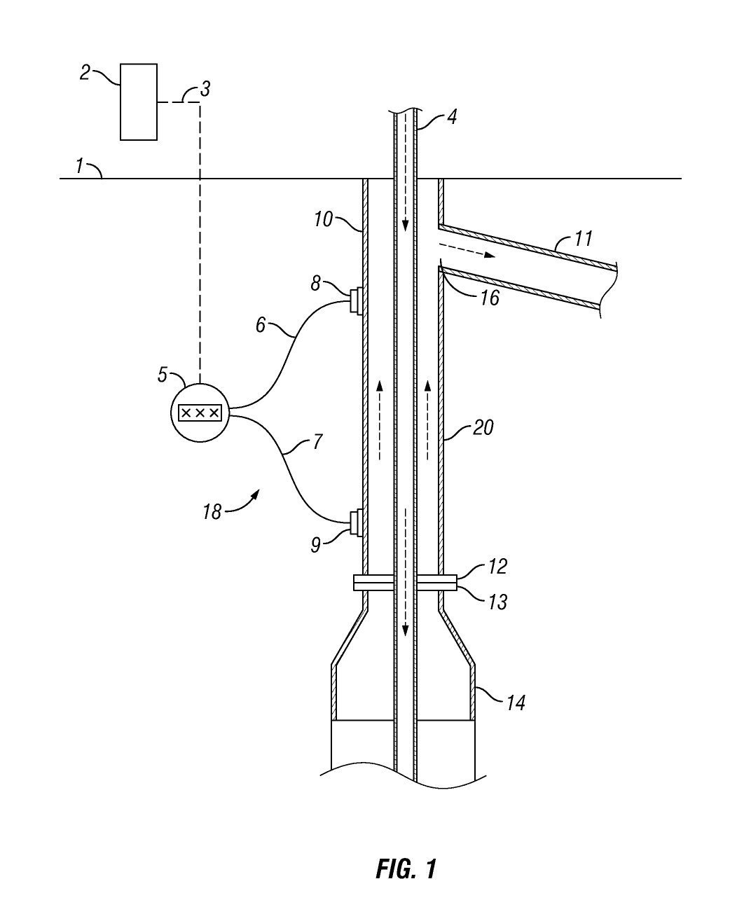

FIG. 1 illustrates a system for monitoring conditions of a fluid from a well (not shown). In certain example embodiments, the system includes a monitoring system 18 coupled to a bell nipple 10. In certain example embodiments, the bell nipple 10 is fitted to a top of a blowout preventer stack 14 that is positioned above a well (not shown). In certain embodiments, the bell nipple 10 includes a pipe portion 20 and a bell nipple flange 12. The bell nipple flange 12 is configured to couple to a blowout preventer flange 13. In certain example embodiments, the bell nipple 10 is disposed around a drill pipe 4. Generally, the pipe portion 20 of the bell nipple 10 is a section of large diameter pipe to which a flow line 11 attaches via a side outlet 16. It will be apparent to those skilled in the art that a bell nipple is a device commonly used on land-based drilling rigs, but that the systems and methods of the present invention described herein is equally applicable to the Riser that is commonly used on offshore drilling rigs. During a drilling operation, drilling fluid is injected downhole through the drill pipe 4 and returns to the surface through an annulus between the drill pipe 4 and the wellbore (not shown). The returning drilling fluid then flows up through the bell nipple 10, in the annulus between the drill pipe 4 and the wall of pipe portion 20, and into the flow line 11. The flow line 11 allows the drilling fluid flowing from drill pipe 4 into the well and returning through the bell nipple 10 to flow back over shakers to mud tanks on a rig (not shown).

The monitoring system 18 is configured to monitor the conditions of the returning drilling fluid in the bell nipple 10. In certain example embodiments, the monitoring system includes at least two separate transducers 8, 9, and an electronic transmitter 5. In certain example embodiments, the at least two separate transducers 8, 9 are installed in a vertical orientation in the bell nipple 10. In certain exemplary embodiments, the transducers 8, 9 are of an electronic type not requiring the use of capillary tubes which connect to the electronic transmitter 5. In certain example embodiments, the at least two transducers 8, 9 include pressure and/or temperature transducers. In other example embodiments, the at least two transducers 8, 9 include additional or different transducer or sensor types. In certain example embodiments, the transducers 8, 9 are mounted to an exterior of the bell nipple 10 by a suitable means well known in the art, including, but not limited to, threaded connections, flanged connections, or hammer union connections.

The transducers 8, 9 are in fluid communication with the drilling fluid (not shown) inside the bell nipple 10 through port holes (not shown) in the bell nipple 10. In certain exemplary embodiments, the transducers 8, 9 are spaced at least 450 millimeters (mm) apart. In certain exemplary embodiments, the transducers 8, 9 are positioned below a bottom edge of the flow line 11. In certain example embodiments, the transducers 8, 9 are configured to sense a pressure reading and/or a temperature reading at the respective positions. In a preferred embodiment, the two or more transducers 8, 9 are connected to a single electronic transmitter 5 via transducer data wires 6, 7. The electronic transmitter 5 can comprise a processor that calculates the differential pressure and/or temperature between the transducers 8, 9. The data is then transmitted via wire 3 from the electronic transmitter 5 to a computer 2 at the rig floor 1, and the differential pressure and/or temperature may be used to continuously and in real-time determine the density, and therefore the mud weight, of the fluid returning from the wellbore. In certain alternative embodiments, the data can be transmitted wirelessly to computer 2. In certain embodiments, the pressure and temperature readings are transmitted by the electronic transmitter 5 to the computer 2 and the computer 2 calculates the differential pressure and the density and level of the fluid based on the data from the transducers 8 and 9. The computer 2 can comprise one or more processors, a memory, and a communications interface and can be embodied in any type of data receiving and processing device such as a desktop computer, a computing portion of a control or data collection system, a handheld mobile device, and the like.

In certain embodiments, the transmitter 5 will continuously and in real-time measure and calculate the fluid density, the density corrected static head, also referred to as fluid level, and/or the fluid temperature from the data collected by the transducers 8, 9. These measured and calculated values may be used to determine the continuous and real-time return drilling fluid density, the continuous and real-time return drilling fluid temperature, and/or the continuous and real-time return drilling fluid level in the bell nipple 10. Generally, the measured and calculated values of the drilling fluid properties may be used to provide an early indication of the influx of fluid into the wellbore, i.e., a kick, the loss of fluid into the formation, the loss of barite (barite sag), the formation temperature zone changes, the gas intrusion into the drilling fluid, and/or the gas breakout in the bell nipple 10.

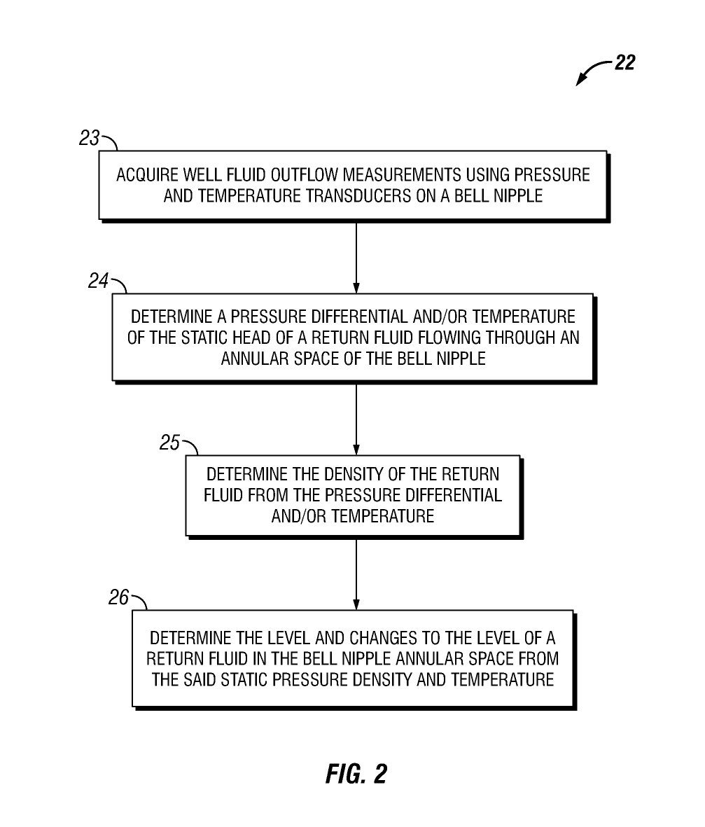

FIG. 2 illustrates a method 22 of monitoring and detecting formation fluid influxes and drilling fluid losses. In certain exemplary embodiments, the method includes acquiring well fluid outflow measurements using pressure and temperature transducers (step 23). In certain example embodiments, the transducers are spaced apart a length along a bell nipple during a period in which drilling operations are performed for the well. The method 22 further includes determining a pressure differential of the static head of a return fluid (step 24). In certain example embodiments, the return fluid is the fluid flowing through an annular space of the bell nipple across said length along the bell nipple during said period. The method 22 also includes determining the density of a return fluid (step 25). In certain example embodiments, the density is determined from said differential pressure and the temperatures measured by the transducers. The method 22 also includes determining the level and changes to the level of a return fluid in the bell nipple annular space from the said density and static head pressures and temperatures (step 26).

In certain example embodiments, the pressure measurements are acquired in a continuous and in real-time fashion. In certain other example embodiments, the pressure measurements are acquired at predetermined time intervals and upon certain conditions. In certain example embodiments, the pressure differential can be determined in a continuous and in real-time fashion or at predetermined time interval or upon certain conditions. The density can also be determined in a continuous and in real-time fashion, in predetermined time intervals, or upon certain conditions. The level and changes to the level can also be determined in a continuous and in real-time fashion, at predetermined times, and upon certain conditions. Measurements of temperature can also be acquired in a continuous and in real-time fashion, at predetermined time intervals, or upon certain conditions. These values can be used by rig systems and services for display and alarming of influx of formation fluid into the well bore (kicks), loss of fluid in the well bore to the formation (loss circulation), mud slumping in the well (barite dropping out of suspension), formation temperature changes, gas intrusion into the drilling mud, and/or gas breakout in the bell nipple.

The present invention provides an improved system for monitoring conditions of drilling fluid for early kick detection over conventional systems. For instance, the current practice is for a drilling fluid services company field engineer to take a sample of fluid only several times per day to determine its density. The present invention makes continuous and in real-time measurements thereby providing more timely indication of the condition of the fluid and earlier indication of formation influxes and losses. Additionally, conventional systems have utilized pressure sensing apparatus that required compressed air that is susceptible to inaccuracies from pressure and temperature fluctuations, freezing, condensation, and maintenance issues. The present invention solves these issues by using robust, highly accurate, and reliable electronic components. Further, conventional systems have required extensive and frequent calibration and testing procedures. The present invention eliminates these limitations by utilizing electronic components that does not require periodic calibration or maintenance.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. While numerous changes may be made by those skilled in the art, such changes are encompassed within the spirit of this invention. Furthermore, no limitations are intended to the details of construction or design herein shown. It is therefore evident that the particular illustrative embodiments disclosed above may be altered or modified and all such variations are considered within the scope and spirit of the present invention.

What is claimed is:

1. A system for monitoring and detecting formation fluid influxes and drilling fluid losses in a well, the system comprising:
a blowout preventer stack;
a bell nipple or marine riser coupled to the blowout preventer stack;
a flow line coupled to a side of the bell nipple;
a drill pipe extending through the bell nipple, the blowout preventer stack, and into the well, wherein fluid flows through the drill pipe into the well and returns through an annulus between the drill pipe and the bell nipple;
a monitoring system coupled to the bell nipple or riser, the monitoring system comprising:
at least two transducers disposed on the bell nipple or riser and in contact with fluid flowing through the bell nipple or riser, wherein the at least two transducers are spaced a distance apart;
a transmitter electronically coupled to the at least two transducers and configured to receive outputs from the at least two transducers; and
a data receiving station in communication with the transmitter and configured to receive a data signal from the transmitter.

2. The system of claim 1, wherein the at least two transducers include at least one pressure transducer.

3. The system of claim 1, wherein the at least two transducers include at least one temperature transducer.

4. The system of claim 1, wherein the transmitter transmits the data signal to the data receiving station via wires or wirelessly.

5. The system of claim 1, wherein two of the at least two transducers are spaced at least 450 millimeters apart.

6. The system of claim 1, wherein the at least two transducers are positioned below the flow line.

7. The system of claim 1, wherein the at least two transducers are in contact with fluid within the bell nipple or riser via at least two corresponding openings in a wall of the bell nipple or riser.

8. A drilling fluid monitoring system, comprising:
a bell nipple or riser, wherein the bell nipple or riser is configured to receive a drilling fluid flowing therethrough;
a flow line coupled to and in fluid communication with the bell nipple, wherein the drilling fluid flows into the flow line from the bell nipple;
a monitoring system coupled to the bell nipple or riser, the monitoring system comprising:
at least two transducers disposed on the bell nipple or riser and in contact with the drilling fluid flowing through the bell nipple or riser, wherein the at least two transducers are spaced a distance apart;
a transmitter electronically coupled to the at least two transducers and configured to receive outputs from the at least two transducers; and
a data receiving station in communication with the transmitter and configured to receive a data signal from the transmitter.

9. The drilling fluid monitoring system of claim 8, wherein the at least two transducers measure the pressure, temperature, or both of the drilling fluid in the bell nipple or riser.

10. The drilling fluid monitoring system of claim 9, wherein the transmitter or the data receiving station determine a density of the drilling fluid in the bell nipple or riser from the pressure measured by the at least two transducers.

11. The drilling fluid monitoring system of claim 8, wherein the at least two transducers include a pressure transducer.

12. The drilling fluid monitoring system of claim 8, wherein the at least two transducers include a temperature transducer.

13. The drilling fluid monitoring system of claim 8, wherein the bell nipple or riser comprises a drill pipe disposed therethrough, wherein the drill pipe delivers the drilling fluid into a well and the drilling fluid returns to the surface through the bell nipple or riser.

14. The drilling fluid monitoring system of claim 8, wherein the transmitter receives outputs from the at least two transducers continuously and in real-time, and wherein the data receiving station receives the data signal from the transmitter continuously and in real-time.

15. A method of monitoring and detecting formation fluid influxes and drilling fluid losses in a well, the method comprising:
acquiring well fluid outflow measurements using pressure and temperature transducers spaced apart a length along a bell nipple during a period in which drilling operations are performed for the well;
determining, by a processor, a pressure differential of a static head of a return fluid in an annular space of the bell nipple or riser across the length along the bell nipple or riser during the period;
determining, by the processor, a density of the return fluid in the bell nipple or riser annular space from the differential pressure; and
determining, by the processor, a level and changes to the level of the return fluid in the bell nipple or riser annular space from the determined density and static pressures and temperatures.

16. The method of claim 15, further comprising:
acquiring measurements of pressure in a continuous and in real-time fashion;
determining the pressure differential in a continuous and in real-time fashion; and
determining the density in a continuous and in real-time fashion.

17. The method of claim 15, further comprising:
determining if a loss event has occurred based on the determined density of the return fluid.

18. The method of claim 15, further comprising:
determining the level and changes to the level of the return fluid in the bell nipple or riser annular space in a continuous and in real-time fashion.

19. The method of claim 15, further comprising:
acquiring the measurements of temperature in a continuous and in real-time fashion.

20. The method of claim 15, wherein the pressure differential is detected via at least two transducers coupled to the bell nipple or riser and in contact with the return fluid within the annular space of the bell nipple or riser.

21. The method of claim 15, further comprising:
determining, by the processor, the density of the return fluid in the bell nipple or riser annular space from the differential pressure and temperature.
